(19) United States
(12) Patent Application Publication
(10) Pub. No.: US 2017/0091791 A1
(43) Pub. Date: Mar. 30, 2017

(54) DIGITAL POWER PLANT SYSTEM AND METHOD

(71) Applicant: General Electric Company, Schenectady, NY (US)

(72) Inventors: Jayanthi SRINIVASAN, San Ramon, CA (US); Sham CHOTAI, San Ramon, CA (US)

(21) Appl. No.: 15/251,626

(22) Filed: Aug. 30, 2016

Related U.S. Application Data
(60) Provisional application No. 62/233,296, filed on Sep. 25, 2015.

(51) Int. Cl. G06Q 30/02; G06N 99/00; G06F 17/50; G06N 5/04; H04L 29/08; H02J 3/38

(52) U.S. Cl. CPC G06Q 30/0202; H04L 67/10; H02J 3/381; G06F 17/5009; G06Q 30/0201; G06N 5/04; G06N 99/005; H02J 2003/007

(57) ABSTRACT

A Digital Power Plant (DPP) deployed on a cloud-based computer system that the enables all components and systems in a fleet of power plants. By digitally extending the various sub-systems in a power plant to the cloud-based computer system, the system enables the power plant or fleet to act and behave optimally with respect to a larger environment of an entire power generation grid.

### CROSS RELATED APPLICATION

This application is a non-provisional of 62/233,296 filed Sep. 25, 2015, wherein the entire contents of this application is incorporated by reference.

### BACKGROUND OF THE INVENTION

The invention relates generally to power generation and distribution over geographically large networks and, more particularly, to methods and systems related to performance optimization and operation of power plants and fleets of power plants.

Electrical power is distributed through large networks, such as power grids, that transmit the power from power plant to power consuming customers, such as homes, factories and office buildings. An individual power plant may be operated in a fleet of commonly owned plants by a power generation company. Each fleet may be owned and operated by a different company. There may be many fleets of power plant and individually operated power plants that distribute electrical power through the power grid.

Electrical power distributed by the power grid is typically sold to customers who are connected to the grid. The price for power is often set by the demand for power. The owners of fleets of power plants do not have complete freedom to set the price for power that they sell. Electrical power is similar to a commodity in that the power generated by one fleet of power plant is equivalent to and sold at the same price as power generated by another fleet.

Each company that owns or operates a fleet of power plants or even a single power plant (or other power generation system) must determine the amount of power to generate for sale over a power grid. The determination is typically based on the anticipated sales price for power, the anticipated demand for power, the cost to generate and distribute power, and the operating condition of the power generation system(s) generating the power. The determination of how much power to generate is performed periodically, such as on a weekly, daily or hourly basis.

The determination of how much power should be produced by an individual power generation system or individual fleet of power generation systems requires various types of data, such as market data on the price of power and cost for fuel to generate power, the expected amount of power to be generated by other power plants, and the number, types and availability of power plants in a particular fleet. The analysis of this data is complex and is conventionally performed using various types of software analytical systems. Collecting and transmitting data to the software analytical systems, generating the analyses and distributing the results of the analyses in a timely manner has proven difficult.

A conventional approach to determining the amount of power a fleet or individual power generation system is an economic dispatch analysis. This economic display analysis determines the overall demand for power as represented by the electrical load on a power grid system. The analysis divides the overall demand among the power plant coupled to the power grid system. Each power generation system generates the amount of power allocated based on the division determined by the economic dispatch analysis.

The economic dispatch analysis relies on the operators power plants periodically generating offer curves and sending offer curves to a power system authority or dispatcher that performs the economic dispatch analysis. The offer curves represent bids from the power plant operators to generate a portion of the electricity required by customers connected to a power grid over a future market period. The offer curves are individually generated by each power plant operator or operator of a fleet of power plants.

The generation of the offer curves may be made based on inadequate or imperfect knowledge of the market demand. Offer curves may not be generated in a uniform manner or generated in a manner that does not optimize the performance of an individual power plant or the overall performance of all power plants. Thus, offer curves provide imperfect data on which to determine the amount of power each power fleet should produce.

The dispatch authority receives the offer curves from the power plants and determines the amount of power each power plant should generate. The dispatch authority attempts to efficiently satisfy the predicted load on the grid by dividing the power to be generated amount the available power plants. The dispatch authority analyzes the offer curves with the objective of finding the lowest cost to generate the amount of power anticipated to be consumed by all customers on the power grid.

The dispatch authority produces load commitment schedules that describes the extent to which each of the power plants or fleets of power plants will be engaged over the relevant time period. The dispatch authority communicates a load commitment to each power generation fleet or independent power plant that indicates the amount of power to be generated by that fleet or plant. Once the commitment schedule is communicated, each power plant or fleet of plants may determine the most efficient and cost-effective manner by which to satisfy its load commitment.

The operator of an individual power generation plant or fleet of plant typically considers the types status and number of power generation units that are available in the fleet or plant, the capacity of each power generation unit to generate power, the operating condition of the power generation unit and the cost to generate power by each of the units.

The power generation plants in each fleet may vary in type. Power generating units may be coal or gas fired boilers that drive steam turbines, individual gas turbines, combined-cycle units that include steam and gas turbines, nuclear power plants, piston driven engines, wind turbines, solar power generation, hydro-power generators and other types of power generators. The availability and cost for power generation of each power generation unit will depend on its type. The actual output and efficiency of a power generation unit also is impacted by external factors, such as variable ambient conditions.

Another factor to be considered in determining the power to be generated by an individual power generation unit is its service life. Machine degradation in power generation units occurs over time and the degradation may have a significant effect on the performance of the generating units. Power generation units require replacement of worn components, timing of maintenance routines, and other factors impact the short term performance of the plant. The maintenance schedules for power generation units needs to be accounted for when generating cost curves during the dispatching process and while assessing the long term cost-effectiveness of the plant.

As an example, gas turbine life typically is impacted by operating patterns that include rates of consumption impacted by hours of operation, load, transients and transient rates of load change, and number of starts. If a gas turbine or a component thereof reaches its “starts limit” before its “hours limit”, the gas turbine or component must be repaired or replaced, even if it has hours-based life remaining. Hours-based life in a gas turbine may be prolonged by its reducing firing temperature, but this reduces efficiency of the gas turbine, which increases cost of operation. Increasing the firing temperature increases efficiency shortens gas turbine life and increases maintenance and/or replacement costs. The operations cycles of a turbine such as its being turned off or ramped up rapidly affect the life consumption rate of the turbine and the fuel quantity consumed by the turbine. Life cycle cost of a thermal engine is dependent on many complex factors, while also representing a significant consideration in the economic efficiency of the power plant.

Given the complexity of modern power plants, particularly those having multiple power generating units, and the market for power, power plant operators struggle to determine the operating settings for their power plant that will maximize economic return and minimize the degradation on the systems.

### SUMMARY OF THE INVENTION

A Digital Power Plant (DPP) has been invented and is disclosed herein. A DPP may be embodied as a cloud-based computer system that the models all power generation units, and other components and systems in a power plant. The DPP includes digital models of the sub-systems, such as gas turbines, of the power generation unit in a power plant. By modeling the various sub-systems in a power plant in a cloud-based computer system, the DPP can be operated as part of virtual fleets of power plants to provide information on how all power plants can be optimally operated. The DPP enables the power plant or fleet to act and behave optimally with respect to a larger environment of an entire power generation grid.

A goal of DPP is to enable harmonious data and control flow between existing systems not only for its day to day operations but also for extending the life of all assets while maximizing return on investment (ROI). The DPP interconnects systems that analyze power generation and shares data between these systems. The DPP sets a foundational system for seamless communication of data related to power generation and the sharing of intelligence and analytical tools.

The DPP can be thought of as a human body. A human body has independent organ systems which must be coordinated and operated as a single human body. Similarly, a power plant or fleet of plants is an independent organ system of a power grid that should operate in a coordinate manner with the entire grid. The organ systems of the human body shares information (nutrients and nerve signals) to coordinate the operation of one organ with respect to another and the entire body Similarly, the DPP shares information among power plants so that the operation of all plants may be coordinated.

The DPP may be logically viewed as a three major organ system. The first organ system is centrally perform Overall Optimization of operations in a power plant and a fleet of power plants, overall optimization includes: (i) optimize subsystems within each power plant; (ii) optimize power plants and fleets by sharing information amount plants and fleets; and (iii) optimize the return on investment (ROI) of power generation by accounting for market conditions when determining the operational setting for the power plant or fleet.

A second major organ system is locally Optimize Plant Operation at the plant; and a third major organ system is Remote Prognostics, Diagnostics and Management. All three major organ systems may be located within a central cloud based computer system, while the third organ system may also have an independent subsystem residing locally on a computer system on site of a power generation plant.

The DPP is a system extends the data communication and analysis associated with a power plant to cloud computing. This extension enables for seamless data and control flow between the various sub-components in power generation units and fleets. Cloud computing also enables optimization of the operation of a power plant thru: prognostic recommendations; optimization of operations of different subsystems of a power plant independently or in concert; rapidly respond to changing market conditions; and sharing all of the knowledge and information relevant to power generation.

The DDP operates as one cohesive systems, where all digital models of power plants and individual power generating units within the plants, data and analytics are synchronized between the plants and the cloud based computing system. This enables the DPP to function as one unified system and allows for the overall operation of a site or sites to be optimized from the cloud and to apply learnings from across the fleet.

A cloud based computing system is disclosed comprising: a digital model of a power generation system including digital models of power plants; digital communication paths through which each of the digital models of the power plants exchange digital data with physical power plants corresponding to the digital model, wherein the digital data includes information regarding the operating condition of the physical power plants, predicted demands for power from each of the physical power plants and predicted schedules of operation for each of the physical power plants and each of the digital models are each configured to model the real time or near real time of the physical power plant corresponding to the digital model; wherein the physical power plants are connected to a power grid and each of the physical power plants is configured to supply power to the power grid; and a processing system configured to monitor and interact with each of the digital models of the power plants and generate analytical reports providing recommendations or commands for operational settings of the physical power plants.

### BRIEF DESCRIPTION OF THE DRAWINGS

Other advantages of this invention are made apparent in the following descriptions taken in conjunction with the provided drawings wherein are set forth, by way of illustration and example, certain exemplary embodiments of the present invention.

FIGS. 1 to 3 are diagrams showing software-based computer systems and data flow between the organ systems for managing fleets of power generation facilities.

FIG. 4 is a flow chart for processing data received from power generation plants or fleets.

FIG. 5 is a diagram showing the operation of digital model of a power generation unit or plant, and the flow of data into and out of the model.

### DETAILED DESCRIPTION OF THE INVENTION

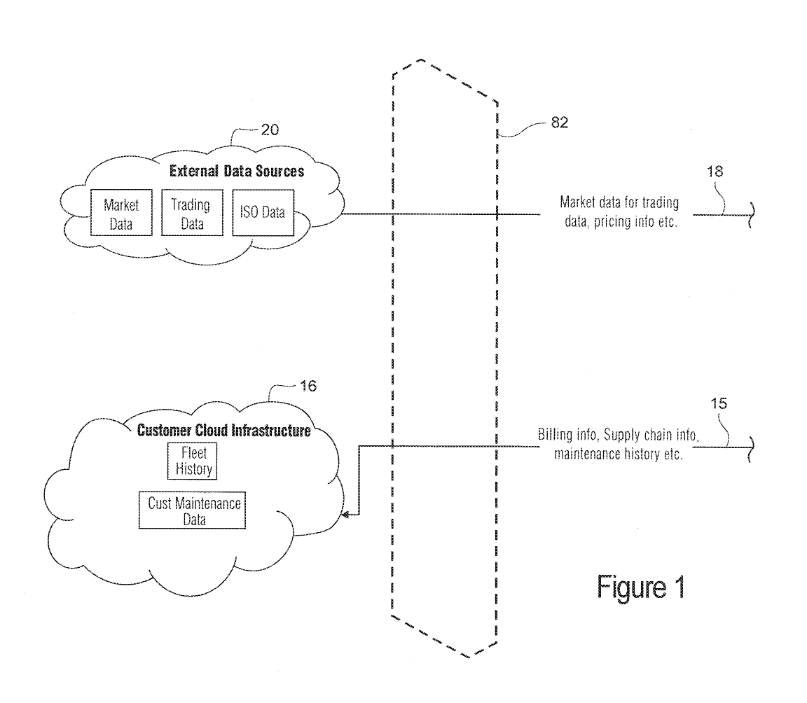

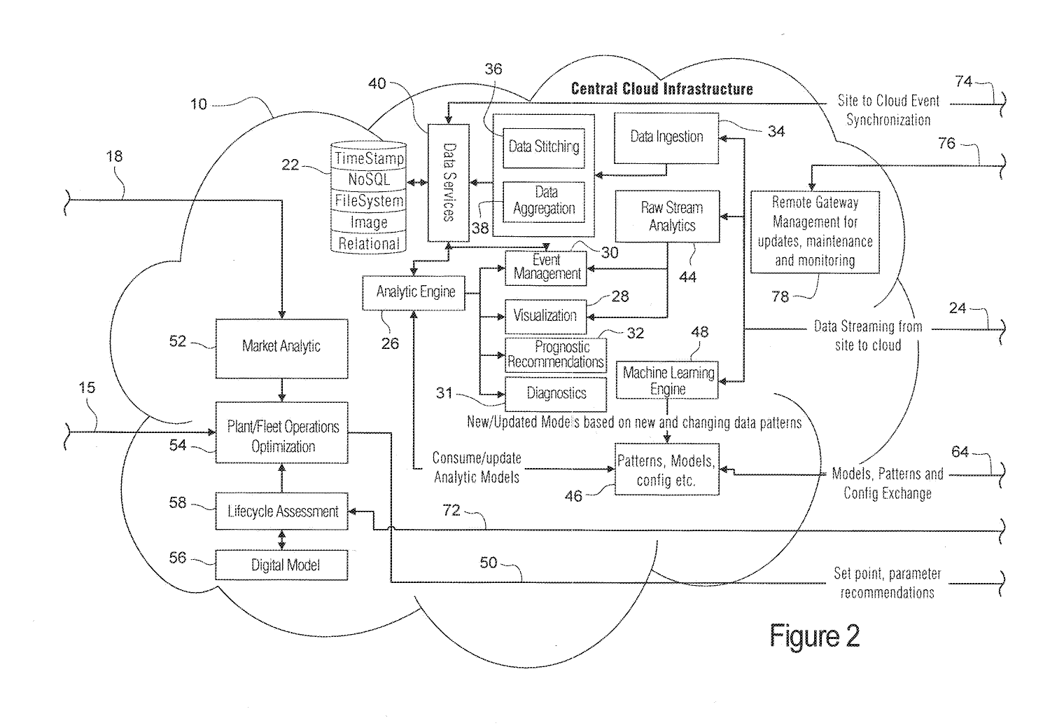

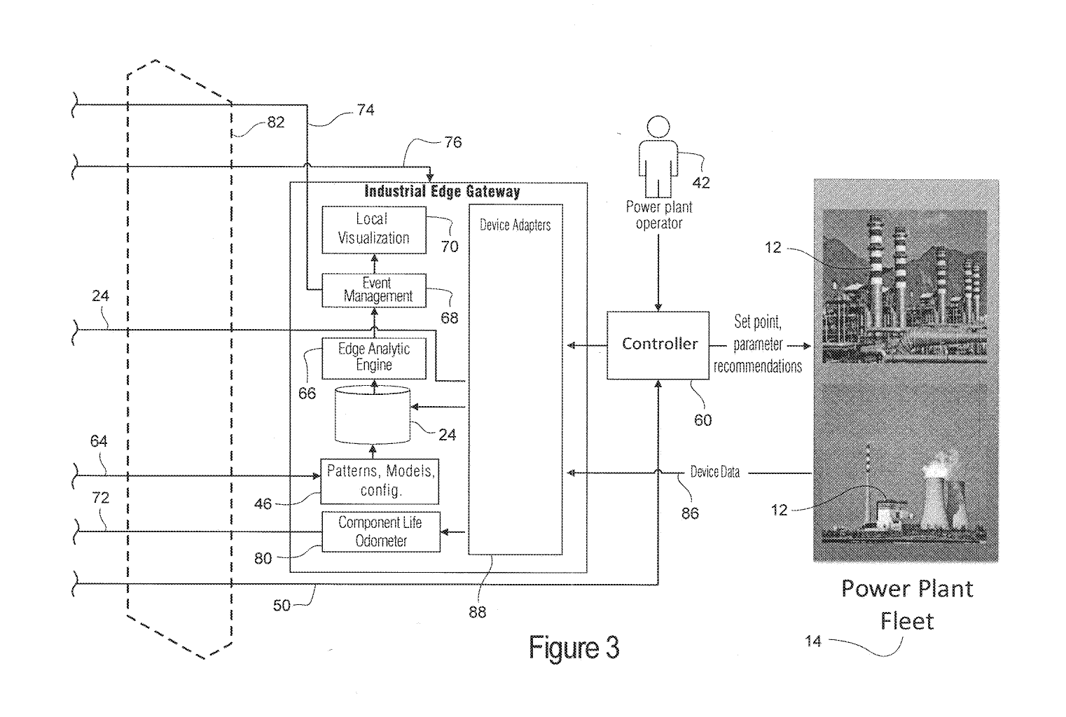

FIGS. 1 to 3 are a diagram a system for managing fleets of power generation plants or an individual facility and, particularly, for handing data needed to manage the fleets. The system includes a central cloud computing system 10 which collects data generated by individual power plants 12 which may be group in fleets 14 of power plants. Each fleet may be operated by a customer, such as a public utility or other entity that owns or operates power plants. Data 15 from the customer is collected from a customer computer system 16 by the central cloud computing system 10. In addition, data 18 about market conditions is collected from external data sources 20. The market condition data may indicate demand for power by end-use customers, such as office buildings, factories and residences, the amount and cost of power being generated and the availability and cost of fuels and other resources needed to operate the power plants in the fleets.

Customers of the system 10 may maintain their data on a customer cloud computer system 16. The customers may be owners or operators of power generation plants and systems, and may own or operate fleets of plants and systems. The fleet may include power generation plants and systems, such as steam turbines, gas turbines, boilers, combined cycle systems, nuclear, piston driven engines wind turbines and solar systems. The data stored on the customer cloud infrastructure may include the history of the fleet, maintenance data of the power plant in the fleet, information for billing the customer for parts and services, and data reported by the customer regarding the customer and its fleet. Data from the customer cloud infrastructure may be sent, upon request, to the system and the customer may request data, such as billing information and part order information, from the system. The system may be protected from the customer cloud infrastructure by the firewall.

The external data sources 20 may include market data about the demand and price for power generated by the power plants, trading data about the costs for the different types of fuels consumed by the different power plants, and ISO/RTO data from Independent System Operators (ISO) or Regional Transmission Organizations (RTO) that publish real-time or hourly generation data by type of fuel or energy source for power plants. The data from external data sources is requested and transmitted to the system.

The central cloud computer system 10 manages and stores data 22 from many power plant sources 15, 18, 20, including raw data 24 from each of the power plants 12. The stored data is used to analyze the operation of the individual power plants and compare the operation of similar types of power plants. Analytical engines 26, such as software algorithms which analyze data, are used to identify trends in the operation of the fleet and identify potential problems in particular power plants. The analytical engines generate reports or alerts 28 about the fleet and individual power plants. The analytical engines may schedule events 30, such as shut-downs or maintenance for power plants or confirm that scheduled events have been performed. The analytical engines may diagnose 31 the source of problems in individual power plants and generate recommendations 32 for the operation or maintenance of individual power plants. The analytical engines could also be used to predict remaining useful life (RUL) of components. The analytical engines may also be used to generate lifing models of, for example, power plants or power generation systems within power plants, recommend optimal operating parameters for power plants and individual power generation systems in a power plant to maximize return on investment (ROI) while extending RUL The recommended optimal operating parameters may be transmitted to plant operators who select and input operating parameters into power plants and individual power generation systems in a plant.

The processing of data by the central cloud computer system 12 may include ingesting 34 the raw data 24. Data ingestion is the process of obtaining, importing, and processing data for later use or storage in databases in data storage 20. Data ingestion often involves altering individual data and files of data by editing their content and formatting the data to conform to the formats for data to be used and stored in the central cloud computer system. In addition to data ingestion, sequential data may be stitched 36 together to form a time sequence of data representing the change of a performance characteristic of a power plant over time. In addition, the data may be aggregated 38 with data from the different sources, such as from other systems within a power plant.

The processed data is managed by a data services system 40 which stores and retrieves data from data storage 22. The data storage may store different types of data related to the operation of the power plants. The types of data may include sequential data which includes a time indicator of when the data was generated, data that is not sequential (NoSQL), a general file system for managing and storing data, image data of plant operations and sensor outputs, and relational data that indicates relationships between different parameters of the operation of a power plant.

All client applications 26, 54, 56, 52, 46, of data 22 are shielded from the complexities of interacting with different storage technologies by the data services system 40. All types of access to stored data 22 is through the data services system. The data services system functions as a librarian for the stored data. The data services system allows for the upgrade upgrading of data storage and data processing, without interfering with the client applications. These data services may also provide the required security that is needed for all data access operations. To provide security, all requests are verified for appropriate authentication and authorization before allowing the data operation to proceed further.

The processing of data by the central cloud computing system 10 is not intended to affect the information contained in the raw data 24 coming from the power plants. However, the processing may unintentionally affect the information or discard some information in the raw data. Further, the processing and storage consumes time, and thus introduces delays to the analysis of the data.

To ensure that time critical data is not deleted or delayed, and to detect and avoid adverse effects due to information lost or changed due to the data processing, the central cloud computer system 16 uses the raw data 24 incoming directly from power plants to detect time critical events using the event management software system 30 and to report critical events using a visualization software system 28 that presents the events to, for example, the power plant operator 42. The raw data may be analyzed by a raw stream analytic software system 44 to identify patterns and anomalies in raw data. The identified patterns and anomalies may be analyzed by the central cloud computer system which may identify events in the operation of one or multiple power plant systems or to enhance the digital model of a power plant system. The identified events may be reported to the event management 30 or displayed by visualization 28 software systems. The raw stream analytic software system reviews and acts on the raw data in real time as the raw data flows in from the power plants.

In addition, the raw data is used to update and calibrate digital models of the power plants and their components, data patterns used to analyze data and detect performance issues in power plants, and other configurations of analyses (collectively 46) used by the analytic engines 26 to evaluate plant performance based on the stored data 22. The raw data is used by a machine learning engine 48 to calibrate, update or otherwise reconfigure the digital models, patterns and other configures 46. An exemplary digital model is disclosed in U.S. Pat. No. 7,742,904, which is incorporated by reference. The machine learning engine 48 may apply raw data as inputs to the models, patterns and configures 46 and compare the power plant performance predicted by the models, patterns and configures with the raw performance data. In another approach, the machine learning engine may use input data retrieved from data storage 22 as inputs to the models, patterns and configures 46 and compare the power plant performance predicted by the models, patterns and configures with corresponding raw performance data. Differences between the predicted performance data and the raw performance data may be used to modify or calibrate the models, patterns and configurations. The lack of differences may be used to authenticate the models, patterns and configurations. Further, data on differences between the predicted performance and the raw performance may be used to continuously or periodically update digital model of power generation assets, such as power generation systems or entire power plants. These digital models may be updated while the asset while it is under operation.

Moreover, there may be different versions of the digital model of the same asset. For example, for one asset there may be digital models for the as-built asset, the as-deployed asset, and the as-operated asset. Having digital versions of the digital models of an asset enables comparison between the different versions, to optimally operate the assets, and to do predictive maintenance on them. These digital versions of models also enable comparison across assets which operate in different environmental conditions to estimate the impact of environment on the useful life of assets.

The machine learning engine 48 continuously monitors incoming raw data 24 to detect patterns of data. Machine learning algorithms can be applied at two levels. At a first level, the algorithms may be applied to identify previously unknown data patterns that could be investigated further by human engineering experts and to identify data patterns associated with an event at one or more of the power plants. At a second level, the machine learning algorithms may be applied to at a richer context and value to the stored data 22 that is collected, stitched and aggregated from various sources.

In addition, the central cloud computer system 10 generates recommendations 50 for power generation levels at individual power plants by recommending operating set points and other operating parameters for the power plants. These recommendations are determined using analytical software engines 52 and a plant/fleet optimization software system 54. The market analytical software engine analyzes market data 18 with information on the demand for power, the cost of fuel and other information related to the market for power or the cost to generate power. Using a report on market information generated by the market analytical software engine, an optimization software system 54 generates the recommendations 50 for operating levels for each power plant. The optimization software system accesses digital models 56 of the power plants and lifecycle assessment software systems 58 that analyze the lifecycle of the physical power plants corresponding to the models. The digital models 56 and lifecycle assessments 58 may be used to digitally simulate cumulative operation of all of the power plants 12 in the fleet(s). The digital simulations may be operated with different power set points (power output levels) and other operating parameters for the power plants in the fleet(s). The plant/fleet optimization system 54 may run digital simulations with many different power levels and other operational settings for the digital power plants.

The lifecycle assessment software tool 58 is a highly distributed, computational intensive software process analyzing data from the component life odometer for each power plant. The lifecycle assessment tool performs different kinds of load assessments to check an equipment's structural integrity over its lifetime. The tool 58 simulates effects of adverse operating conditions on equipment's longevity and recommends parameters to safely operate them in their extended operating range for increased energy production, while maintaining safety and integrity.

The lifecycle assessment software tool 58 evaluates the data 72 from the component life odometer 80 and generates data used by digital models 56 that simulate the operation of the power plant and the optimization software system 54 that determines optimal operating settings for the plant. The digital model 56 with the life assessment 58 may be used to evaluate effects of different operational settings for the plant. Equipment performance for different settings can be simulated using digital model and the lifecycle assessment may be repeated for each new set of operating conditions. The digital model generates information indicating the performance of the plant at the different settings. The plant/fleet operations optimization software system 54 considers the performance information and information about the market demand for power to set the operating parameters for optimal operation of the equipment while still in the safe operation zone. This process is repeated until desired performance can be achieved while still operating equipment under safe conditions.

The plant or fleet operations optimization software system 54 is used to optimize performance of each of the power plants 12 in the DPP based on the market conditions determined by the market analytic 54 and the optimal operating conditions for the power plants as determined using the digital models 56 and lifecycle assessment tool 59. The operations optimization software system uses external data sources 20 and data 15 supplied by customers operating the power generation units to recommend optimal operating parameters for individual power generation units. Some of the data sources are historical data of market conditions, the operating history of the fleet, and maintenance data for each of the power plants. Some of these data sources may reside in a customer's computer infrastructure 16 and some could be leveraged from third party data sources 20 such as thru purchase of subscription to the data source.

The optimization system 54 may generate a report on the set of power levels and operational settings that results in the lowest cost to generate power or provides the greatest return on the investment (ROI) in the fleet(s) of power plants. The ROI may include as a factor the lowest power generation cost and may also reflect the costs associated with the degradation (wear and tear) on the power plant. The optimal recommended power levels and operational settings 50 are transmitted to the on-site computer controller 60 for each power plant or fleet of power plants. The power plant operator 42 at each power plant or fleet of power plants may review the recommended power levels and operation settings and authorize the computer controller 60 to operate the power plant or fleet at the recommended levels and settings. Alternatively, the controller 60 may automatically operate the power plants or fleet at the recommended power levels and settings.

The central cloud computer system 10 need not provide all of the analyses of an individual fleet of power plants or an individual power plant. A local computer system 62 (industrial edge gateway) provides on-site analyses of each power plant or fleet of plants. The local computer system 62 is near (proximate) the power plant and thus has more ready access to data from the plant, without suffering delays due to data transmission over the internet. The local computer system 62 runs some of the same digital models, data recognition patterns and plant simulation configurations 46 that are used by the central cloud computer system. These digital models, patterns and other configurations are shared and updated by a data link 64 between the local computer and the central cloud computer system.

The on-site computer system 60 receives and stores the raw data generated by its power plant and uses the raw data and the digital models, patterns and other configurations to conduct analyses 66 of the operation of power plant. Based on the analyses, the local computer system schedules events 68, such as maintenance, to occur at the power plant and generates reports 70 regarding the operation of the power plant. The local computer system 60 communicates with the central cloud computer system to transmit raw data 24, report on the operational life 72 of the power plant and its components, synchronize 74 reported events, and update the digital models, patterns and other configurations via data link 64.

The local computer system 60 may directly communicate via data link 76 with a remote gateway management system 78 in the central cloud computer system 10. The remote gateway management system may be used to remotely operate and monitor any of the power plants 12. For example, the remote gateway management system may be used to transmit or receive updates regarding the status, operation or maintenance schedule for each of the power plants.

The local computer system may run a software based analytical tool referred to a component life odometer 80 which continuously collects samples of specific configurable data sets from the operating components or equipment in a power plant. The data sets are used to determine the operational age of the components or equipment. The component life odometer 80 is a tool that collects different kinds of data points in a DPP under different load conditions, at regular configurable intervals. The data collected helps in understanding of how the power plant operates under varying load conditions. These data points are then securely transmitted to a cloud hosted application that does complex analyses to recommend a safe operating range for enhance power production. The data collected by component life odometer 80 is leveraged by the lifecycle assessment software tool 58 to compute the remaining useful life of the component or equipment, and determine the effects of continued operation on the asset characteristics.

Power plants 12 and their equipment are built and configured to operate within operating parameter range. Though the equipment are normally recommended and operated well within their limits, there is usually a range to which the plant and its equipment can be extended to safely operate in, without adversely affecting their safety and lifespan. The component life odometer provides data indicating the operational condition of components within each power plant. The lifecycle assessment system 58 may determine whether the component is operating safely with limits or extended limits for the component.

A firewall 82 protects the central cloud computer system 10 with respect to external data sources or other external computer systems. The firewall may check that the data flowing into the central cloud computer system does not have a computer virus or that an external computer does not gain unauthorized access to the system 10.

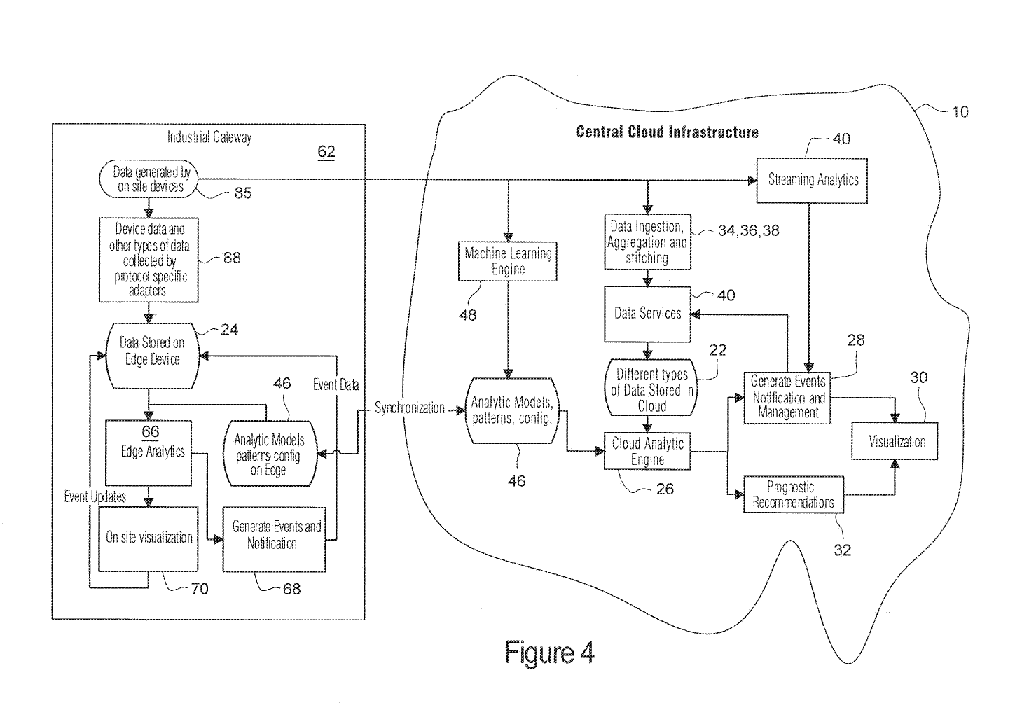

FIG. 4 is a flow chart showing the collection, transfer and processing of data related to power generation and determining optimal power level recommendations for power plants.

The data indicating the operation of equipment is streamed 84 by the local computer system 62 to the central cloud computing system cloud 10. The data may be generated 85 by the local computer system 62 or may be device data 86 generated by sensors, monitoring equipment or other devices directly connected to the power plant and individual components of the plant. The device data 86 enters the local computer system 62 through data adapters 88 that covert the device data into formats suitable for the local computer system and for transmission to the central could computer system 10.

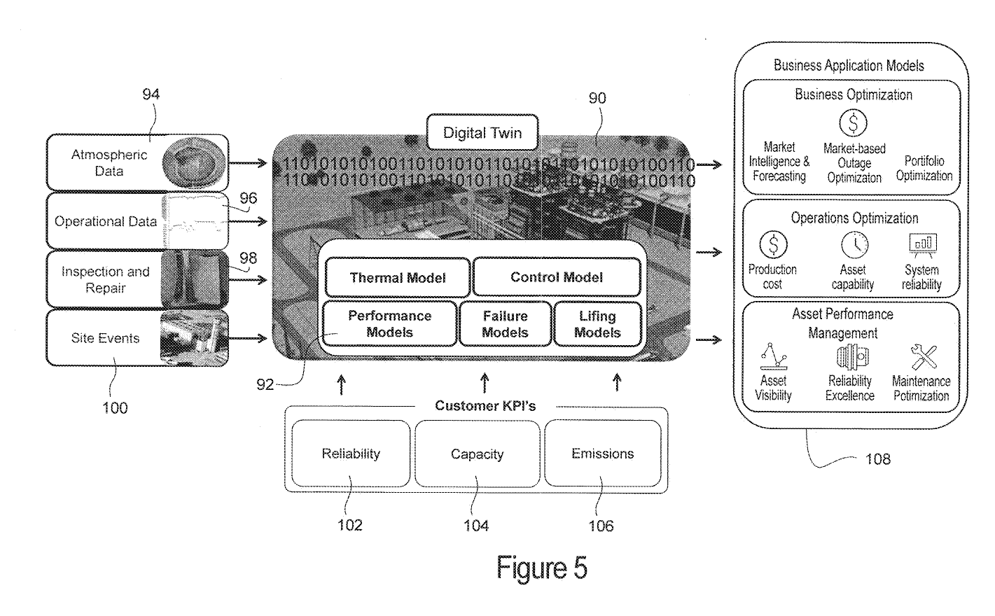

The processing of data, such as the raw data, is shown in FIG. 5 using the reference numbers applied to FIGS. 1 to 3. The data flow shown in the process steps shown in FIG. 5 are evident from the figure and the above description of the software systems shown in FIGS. 1 to 3.

Real time analytics 44 are performed as the raw data is being streamed and in parallel to the processing 34, 36, 38 of the raw data in to formats and structures suitable for storage 22. The streaming analytics 44 may be performed at different stages to capture anomalies and detect patterns in the raw data. For critical analytics, the streaming analytic may be performed 66 at the local computer system so that critical events may be immediately detected and acted upon on site at the power plant. The streaming analytics 44 to detect less critical but time sensitive events are performed in the cloud computer system 10 on the raw data before the data before it is ingested 34. The streaming analytics in the cloud system may be more complex analyses than is performed by the local computer system. The results of the streaming analytics 44 and the on-site analytics by the local computer system may be reported as critical events to the system operator. The analytics that are not time sensitive or do not require immediate actions, may be performed using the stored data and the analytic software engine 26 that may run complex and time consuming software algorithms

Collecting data and performing computations in a cloud based computer system and generating recommended operating parameters and settings for a fleet(s) of power plants is advantageous because the cloud computer environment is highly scalable and the analytic engines 26, 54 and machine learning engines 48 needed to perform the computations operate best when they have information from an entire fleet(s) of power generation plants. The cloud enables sharing of information learned for one plant with other similar power plants. The cloud also allows for rapid comparison of different power plants having similar equipment. By digitizing the whole power plant and fleet as the DPP, the learnings and information flow as data freely between the different power plants to enable each plant operator to optimize the operation of his plant in the context of the entire grid for power generation. The cloud computer system 10 provides secure access to data stored within the system 10 and to data held by the customer. The customer data access may be audited and controlled by the customer.

FIG. 5 is a diagram illustrating a digital model of a power plant 90. A model (Digital Twin) is a software model and visualization software tool that is used in conjunction with the lifecycle assessment tool 58. The digital model enables creation of a digital equivalent of an individual power plant in the DPP or a power generation component to a plant in the DPP. The digital model provides a safe and easy to use digital equivalent of a plant or its equipment to optimize the power level and operational settings of the plant and equipment. By running the digital model, the simulated behavior of the plant or equipment may be determined for different operating parameters, load conditions and environmental conditions. The simulation is done without subjecting the actual plant or equipment to actual operating conditions.

The digital model 90 may simulates the operation of a power plant or a component of the plant. The digital model may include one or more types of digital models 92 such as a thermal model, a control model, performance model, failure model and lifeing model. The different types of models may be used to support different types of analytical software engines. Each of the types of models requires data inputs of various parameters and conditions. For example, data regarding environmental conditions 94, such as atmospheric conditions; operational data 96 such as the current operational state of a power plant or component of the plant; data 98 regarding the inspection and repair of components in a plant, and data 100 indicated schedules of events, such as shut down events.

Other sources of input data include the customer specific key performance indicators (KPI), such as desired levels of plant reliability 102, plant capacity 104 and emissions 106. The digital model 90 may also be used to generate results for business modeling 108.

The digital model 90 need not be a static model but may be a continuously evolving digital model that is constantly updated as the parameters are tweaked and adjusted for optimal operation and market conditions. Over time, the digital model may become more sophisticated, accommodating of a wider range of operational settings and gain simulation capabilities.

A combination of optimization techniques can be simulated using the digital model, and results of the optimization systems may be evaluated and validated using the digital model.

The digital model 56, lifecycle assessment 58, and the operations optimization system 54 are used in conjunction with each other in a closed loop system. These systems may be operated to vary operating parameters and power levels of the digital model to simulation operation of all of the power plants in the DPP under various conditions and to observe the behavior of the DPP under the various conditions.

The digital model 56 in conjunction with the lifecycle assessment system 58 and the optimization system 54 generate the recommend optimal operating parameters and settings, based on market conditions, for each power plant or fleet of plants. The market analytic system 52 evaluates various market parameters, such as power demand, power supply, advice from the power grid, price for power produced and cost of fuel to generate a recommend a power generation target for the DPP (which includes all of the power plants and fleets in the DPP). The power level for each power plant in the DPP is recommended based on the optimization process run by the operations optimization system 54 that utilizes the power generation target recommended by the market analytic system. By integrating these systems recommended levels of power generation for each power plant in the DPP can be made in real time and by continuously analyze incoming data, market conditions, load data, environmental factors and feed each other for optimized decision making.

The DPP collects data 86 from different data sources, some of which are in the power plant and others may be external to the power plant. The DPP collects and processes data from most known data generating devices within the power generation units in the fleet(s). The data collection and processing uses an architecture that collects data at the local computer system and transmit the data to the cloud. In addition, the cloud is synchronized with the local computer system with respect to data, power generation events, power generation unit configuration, analytic models that evaluate power generation unit operation, and provides secure remote management of individual power generation units.

Extensibility to collect data from different types of assets is achieved by modularizing data collection in the form of adapters. Each protocol has its own adapters to be able to connect, authenticate and subscribe to data streams from to in an extensible manner. The local computer (edge gateway) has remote management capabilities to be able to monitor, update configuration, upgrade software which allows for remote deployment of new adapters to communicate with new devices on the site.

Once the data is collected from equipment, some critical, high value analytics are performed on the raw data to identify tier one events. Once Edge Analytics identify critical events, the gateway is configured to handle events and notification in a manner that is most appropriate for the site and plant. These analytics are in addition to the ones that run on controllers and supervisory control and data acquisition (SCADA) servers. These edge analytics are more sophisticated and can fully leverage the processing power of the gateway. As the gateway is built to be in synchronization with cloud system, events identified locally are also aggregated with the cloud solution. Since Edge Gateway and its counterpart in Cloud in fact act as a unified system, they also share updated analytic engines, rules and models to effectively identify anomalies earlier and closer to the source.

Data is collected from onsite data sources of all assets in a site, through the Edge Gateway are streamed to cloud infrastructure thru adapters that are customized for the nature of data being transferred. The data streaming is optimized for near real time transfers. Since the Edge Gateway also has the capacity to store data for a limited duration, data loss at cloud is negligent to minimal In the event of disruption in communication, Edge Gateway caches data until connectivity is restored and streams it.

The data collected from onsite devices could be streamed at different data rates and resolution to data ingestion services running in the cloud. This data transmission could be accomplished via multiple means including but not limited to web service calls, message queues, HTTP post mechanism etc. As storage is cheap, an extract, load transform (ELT) approach may be used where all incoming data is first stored, before applying any kind of transformation. Data ingestion could be accomplished using technologies like “Data Torrent”.

The data that is collected could range from operational data like tag data, event data or data from extraneous sources like meteorological data. The cloud infrastructure hosts several technologies for stitching and aggregating data from other sources like central historian, global asset database, historical events etc. Once the data has been aggregated it is stored in a variety of data stores. The storage technology is optimized for the nature of data and the querying and processing requirements.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise.

We claim:

1. A method comprising:
collecting raw data from a power generation unit, wherein the raw data contains information regarding the performance of the power generation unit;
transmitting the raw data from a computer system proximate the power generation unit to a cloud based computer system;
processing the raw data by the cloud based computer system, wherein the processing of the raw data includes converting the raw data to conform to a data format determined or used by the cloud based computer system;
storing the converted raw data in a non-transitory memory system;
using the converted raw data and a digital model of the power generation unit to generate predicted performance data of the power generation unit;
comparing the predicted performance data to the raw data, and
modifying the digital model based on the comparison.

2. The method of claim 1 wherein the raw data includes data generated by sensors monitoring equipment in the power generation unit.

3. The method of claim 1 wherein the comparison of the predicted performance in performed using machine learning algorithms.

4. A method comprising:
collecting raw data from a power generation unit, wherein the raw data contains information regarding the performance of the power generation unit;
transmitting the raw data from a computer system proximate the power generation unit to a cloud based computer system;
processing the raw data by the cloud based computer system, wherein the processing of the raw data includes converting the raw data to conform to a data format determined by the cloud based computer system;
simultaneously with and separately from the processing of the raw data, monitoring the raw data to detect a certain time critical event, and
in response to the detection of the certain time critical event, generating a report and presenting the report to a system operator of the power plant.

5. The method of claim 4 wherein the monitoring of the raw data is performed by a local computer system proximate to the power generation unit and the processing of the raw data is performed remotely by a cloud based computing system.

6. A method comprising:
analyzing market data of power demand on a power grid and generating a report of the power demand for a fleet of power plants;
simulating the operation of the fleet using a digital model of each power plant in the fleet;
optimizing the level of power to be generated at each of the power plants in the fleet to achieve the reported power demand for the fleet, and
distributing the optimized level of power to be generated for each power plant to the power plant in the fleet corresponding to the optimized level of power.

7. The method of claim 6 further comprising assessing the life of each power plant in the fleet and using the assessed life in the optimization of the level of power.

8. The method of claim 6 wherein the analyzing of the market data, the simulation of the operation and the optimization of the fleet are performed by a central cloud computing system.

9. A cloud based computing system comprising:
a digital model of a power generation system including digital models of power plants;
digital communication paths through which each of the digital models of the power plants exchange digital data with physical power plants corresponding to the digital model, wherein the digital data includes information regarding the operating condition of the physical power plants, predicted demands for power from each of the physical power plants and predicted schedules of operation for each of the physical power plants and each of the digital models are each configured to model the real time or near real time of the physical power plant corresponding to the digital model;
wherein the physical power plants are connected to a power grid and each of the physical power plants is configured to supply power to the power grid; and
a processing system configured to monitor and interact with each of the digital models of the power plants and generate analytical reports providing recommendations or commands for operational settings of the physical power plants.

10. The cloud based computer system of claim 9 wherein the physical power plants are connected to a power grid and the digital model of the power generation system includes a digital model of the power grid, and the processing system is configured to generate the analytical reports base, at least in part, on predicted demands for power from the power grid.
